(19) United States
(12) Patent Application Publication
(10) Pub. No.: US 2020/0132180 A1
(43) Pub. Date: Apr. 30, 2020

(54) CONNECTION-DISCONNECTION DEVICE AND DIFFERENTIAL DEVICE

(71) Applicant: JTEKT Corporation, Osaka-shi (JP)

(72) Inventors: Yuji TSUZUKI, Chiryu-shi (JP); Hiroshi TAKUNO, Nukata-gun (JP); Makoto NISHIJI, Kariya-shi (JP); Ryohei SHIGETA, Anjo-shi (JP); Yoshinao IWASE, Nagoya-shi (JP); Keita NOMURA, Kariya-shi (JP)

(73) Assignee: JTEKT Corporation, Osaka-shi (JP)

(21) Appl. No.: 16/664,991

(22) Filed: Oct. 28, 2019

(30) Foreign Application Priority Data
Oct. 30, 2018 (JP) 2018-204305

(51) Int. Cl. F16H 48/24; F16D 11/14; F16H 48/34

(52) U.S. Cl. CPC F16H 48/24; F16H 48/08; F16H 48/34; F16D 11/14

(57) ABSTRACT

A connection-disconnection device configured to switch between a connected state and a released state of a side gear and a coupling shaft, each supported by a case member so as to be rotatable relative to the case member. The connection-disconnection device has an input shaft coupled to the side gear so as not to be rotatable relative to the side gear, axial movement of the input shaft being restricted with respect to the side gear, a dog member coupled to the coupling shaft so as not to be rotatable relative to the coupling shaft and so as to be movable with respect to the coupling shaft in an axial direction, and a moving mechanism configured to move the dog member back and forth in the axial direction. Each of the input shaft and the dog member has an annular meshing portion that mesh with each other. The dog member has a collar provided on an outer peripheral side with respect to the meshing portion, the collar configured to receive a flow resistance of lubricating oil accommodated in the case member when the dog member is moved in the axial direction.

### INCORPORATION BY REFERENCE

The disclosure of Japanese Patent Application No. 2018-204305 filed on Oct. 30, 2018 including the specification, drawings and abstract is incorporated herein by reference in its entirety.

### BACKGROUND OF THE INVENTION

### 1. Field of the Invention

The present invention relates to a connection-disconnection device for connecting and disconnecting two rotating members, and a differential device provided with the connection-disconnection device.

### 2. Description of the Related Art

Hitherto, some drive force transmission systems of a vehicle are provided with a differential device having a connection-disconnection device that selectively connects two rotating members. For example, see WO 2015/056330.

In a differential device described in WO 2015/056330, a clutch member is coupled to a differential case so as to be movable in an axial direction and non-rotatable with respect to the differential case. The differential case houses a pair of side gears and a pair of pinion gears. The clutch member has an annular base portion housed in the differential case and a plurality of protrusions that protrude from the base portion toward one side in the axial direction. Meshing teeth are formed on the base portion on an end surface on the other side in the axial direction that faces a gear back surface of one side gear. Each of the protrusions are respectively inserted through through holes formed on a side surface of the differential case.

An electromagnet composed of an electromagnetic coil and a core, a plunger that is composed of a magnetic material and that moves in the axial direction under a magnetic force of the electromagnet, and a ring member composed of a nonmagnetic member that moves together with the plunger are disposed outside the differential case. When the electromagnetic coil is energized, the plunger presses the protrusions of the clutch member via the ring member. Thus, the meshing teeth of the base portion mesh with the meshing teeth formed on the gear back surface of the one side gear, so that the one side gear and the differential case are brought into a differential lock state in which the one side gear and the differential case are coupled to each other so as not to be relatively rotatable. When the energization of the electromagnetic coil is interrupted, an urging force of an urging member disposed between the one side gear and the clutch member separates the clutch member from the one side gear, and the differential lock state is released.

In the differential device configured as described above, when the electromagnetic coil is energized, the meshing teeth of the clutch member and the meshing teeth of the one side gear collide to generate a collision noise. The collision noise may be heard as an abnormal noise to an occupant such as a driver and may cause discomfort thereto.

### SUMMARY OF THE INVENTION

An object of the present invention is to provide a connection-disconnection device and a differential device that can suppress the generation of abnormal noise.

A connection-disconnection device according to an aspect of the present invention is a connection-disconnection device configured to switch between a connected state in which a first rotating member and a second rotating member are coupled to each other so as not to be rotatable relative to each other, and a released state in which the first rotating member and the second rotating member are rotatable relative to each other, the first rotating member and the second rotating member each supported by a case member so as to be rotatable relative to the case member. The connection-disconnection device includes: a fixed member coupled to the first rotating member so as not to be rotatable relative to the first rotating member, axial movement of the fixed member being restricted with respect to the first rotating member; a movable member coupled to the second rotating member so as not to be rotatable relative to the second rotating member and so as to be movable with respect to the second rotating member in an axial direction; and a moving mechanism configured to move the movable member back and forth with respect to the second rotating member in the axial direction. Each of the fixed member and the movable member has an annular meshing portion formed by arranging a plurality of meshing teeth in a circumferential direction. When the movable member is moved toward the fixed member by the moving mechanism, the meshing portion of the movable member and the meshing portion of the fixed member mesh with each other. The movable member has a wall portion with an enlarged diameter provided on an outer peripheral side with respect to the meshing portion, the wall portion configured to receive a flow resistance of lubricating oil accommodated in the case member when the movable member moves in the axial direction.

According to the above aspect of the connection-disconnection device, the generation of abnormal noise can be suppressed.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic diagram showing an example of a configuration of a four-wheel drive vehicle equipped with a differential device according to a first embodiment of the present invention;

FIG. 2 is a sectional view of the differential device including a connection-disconnection device;

FIG. 3A is a sectional view showing a part of the connection-disconnection device in a non-operating state;

FIG. 3B is a sectional view showing the part of the connection-disconnection device in an operating state;

FIG. 4A is a view of a main body of a dog member as viewed from an input shaft side;

FIG. 4B is a view of the main body and a collar of the dog member as viewed from the input shaft side;

FIG. 5A is a plan view of an armature;

FIG. 5B is a side view of the armature;

FIG. 6A is a sectional view showing a differential device according to a second embodiment of the present invention, specifically showing a part of a connection-disconnection device in a non-operating state; and

FIG. 6B is a sectional view showing the differential device according to the second embodiment of the present invention, specifically showing the part of the connection-disconnection device in an operating state.

### DETAILED DESCRIPTION OF EMBODIMENTS

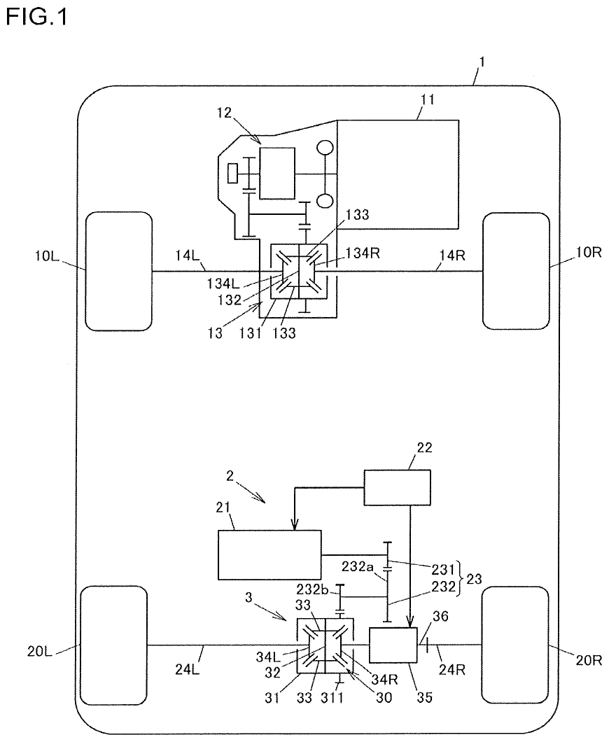

An embodiment of the present invention is described with reference to FIGS. 1 to 5. FIG. 1 is a schematic diagram showing an example of a configuration of a four-wheel drive vehicle equipped with a differential device according to a first embodiment of the present invention. In the four-wheel drive vehicle 1, right and left front wheels 10R, 10L are driven by an engine 11 serving as a main drive source, and right and left rear wheels 20R, 20L are driven by an auxiliary drive device 2 serving as an auxiliary drive source. The auxiliary drive device 2 has an electric motor 21 and a control device 22.

A driving force of the engine 11 is shifted in speed by a transmission 12 and distributed to right and left drive shafts 14R, 14L via a front differential 13 that allows a differential operation. The front differential 13 has a differential case 131, a pinion shaft 132, a pair of pinion gears 133, 133, and a pair of side gears 134R, 134L. Opposite ends of the pinion shaft 132 are supported by the differential case 131. The pinion gears 133, 133 are axially supported by the pinion shaft 132. Each of the side gears 134R, 134L mesh with each of the pinion gears 133, 133, with their gear axes orthogonal to each other. The right and left drive shafts 14R, 14L are coupled to the side gears 134R, 134L, respectively, so as to be non-rotatable with respect to the side gears 134R, 134L.

A drive force of the electric motor 21 of the auxiliary drive device 2 is decelerated by a speed reduction mechanism 23 and transmitted to the differential device 3. The differential device 3 distributes the transmitted drive force to right and left drive shafts 24R, 24L serving as a pair of drive shafts while allowing a differential operation. The differential device 3 has a differential case 31, a pinion shaft 32, a plurality of pinion gears 33, 33, a pair of side gears 34R, 34L, a connection-disconnection device 35, and a coupling shaft 36. The differential case 31 is rotated by the drive force of the electric motor 21. Opposite ends of the pinion shaft 32 are supported by the differential case 31. The pinion gears 33, 33 are axially supported by the pinion shaft 32 and rotate together with the differential case 31. Each of the side gears 34R, 34L mesh with each of the pinion gears 33, 33.

In the present embodiment, a single pinion shaft 32 is supported by the differential case 31, and the pinion gears 33 are axially supported by the single pinion shaft 32. Each of the side gears 34R, 34L mesh with each of the pinion gears 33, 33, with their gear axes orthogonal to each other. The number of pinion shafts 32 and pinion gears 33 is not limited to this, and the pinion gears 33 may be axially supported by two pinion shafts 32, with each pinion shaft 32 axially supporting the pair of pinion gears 33.

The speed reduction mechanism 23 has a pinion gear 231 and a speed reduction gear 232. The pinion gear 231 is fixed to a shaft of the electric motor 21. The speed reduction gear 232 has a large-diameter gear portion 232a and a small-diameter gear portion 232b coupled to each other so as to be non-rotatable with respect to each other. The large-diameter gear portion 232a meshes with the pinion gear 231. The small-diameter gear portion 232b meshes with a ring gear 311 fixed to the differential case 31.

The drive shaft 24L is directly coupled to one side gear 34L of the side gears 34R, 34L. The drive shaft 24R can be selectively coupled to the other side gear 34R via the connection-disconnection device 35 and the coupling shaft 36. One end of the drive shaft 24R is fixed to the coupling shaft 36 so as not to be rotatable relative to the coupling shaft 36. The connection-disconnection device 35 can selectively connect the side gear 34R and the coupling shaft 36. That is, the connection between the side gear 34R and the drive shaft 24R is allowed and prohibited by the connection-disconnection device 35.

When the connection between the side gear 34R and the coupling shaft 36 is prohibited by the connection-disconnection device 35, a differential gear mechanism 30 including the pinion gears 33 and the side gears 34R, 34L is idled, and the drive force of the electric motor 21 is not transmitted to the drive shafts 24R, 24L. In other words, when the connection between the side gear 34R and the coupling shaft 36 is prohibited by the connection-disconnection device 35, the drive shafts 24R, 24L can rotate even when the electric motor 21 is stopped.

The electric motor 21 and the connection-disconnection device 35 are controlled by the control device 22. After a vehicle that is stopped starts moving until a vehicle speed reaches a predetermined value, the control device 22 controls the rotation of the electric motor 21 to generate the drive force, with the side gear 34R and the coupling shaft 36 coupled to each other by the connection-disconnection device 35 so as not to be relatively rotatable. In this case, the drive force of the electric motor 21 is transmitted to the right and left rear wheels 20R, 20L via the differential device 3 and the right and left drive shafts 24R, 24L, and the four-wheel drive vehicle 1 establishes a four-wheel drive state.

Meanwhile, when the vehicle speed exceeds the predetermined value, the control device 22 prohibits the connection between the side gear 34R and the coupling shaft 36 by the connection-disconnection device 35 and stops the electric motor 21. Thereby, the four-wheel drive vehicle 1 establishes a two-wheel drive state in which only the right and left front wheels 10R, 10L are driven by the engine 11. By prohibiting the connection between the side gear 34R and the coupling shaft 36 by the connection-disconnection device 35, the electric motor 21, the pinion gear 231 and the speed reduction gear 232 of the speed reduction mechanism 23, and the differential case 31 are not rotated by reverse input from the right and left rear wheels 20R, 20L. Thus, running resistance associated with the rotation is reduced.

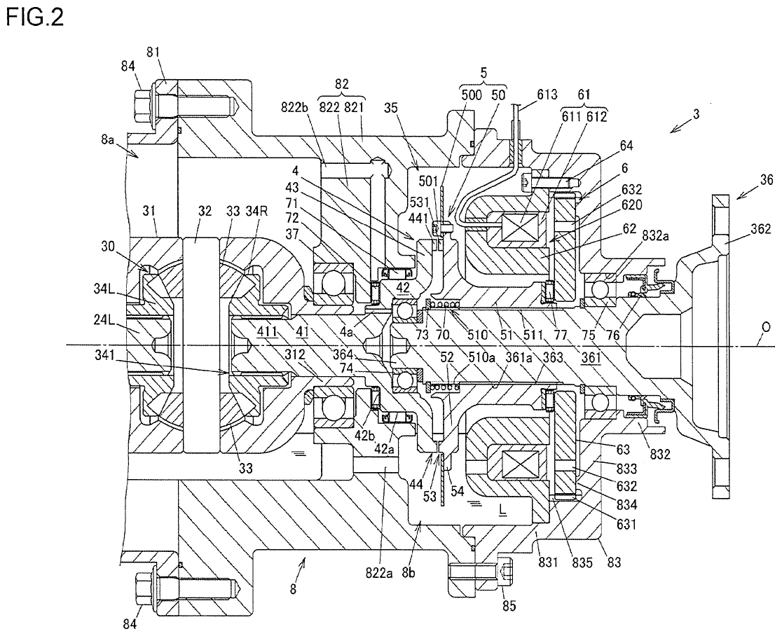

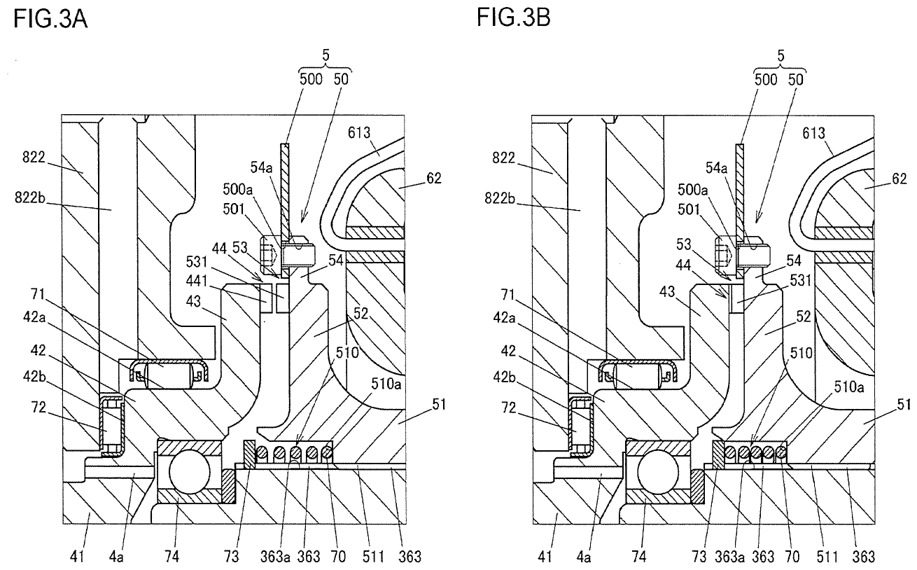

Next, the configuration of the connection-disconnection device 35 will be described. FIG. 2 is a sectional view of the differential device 3 including the connection-disconnection device 35. FIG. 3A is a sectional view showing a part of the connection-disconnection device 35 in a non-operating state, and FIG. 3B is a sectional view showing the part of the connection-disconnection device 35 in an operating state. In FIGS. 2, 3A, and 3B, an upper side of the drawings corresponds to an upper side in a vertical direction when the connection-disconnection device 35 is mounted on the four-wheel drive vehicle 1, and a lower side of the drawings corresponds to a lower side in the vertical direction when the connection-disconnection device 35 is mounted on the four-wheel drive vehicle 1.

The connection-disconnection device 35 has an input shaft 4, a dog member 5, an electromagnetic actuator 6, and a coil spring 70. The input shaft 4 is coupled to the side gear 34R so as not to be rotatable relative to the side gear 34R. The dog member 5 is coupled to the coupling shaft 36 so as not to be rotatable and so as to be axially movable relative to the coupling shaft 36. The electromagnetic actuator 6 moves the dog member 5 in a first axial direction. The coil spring 70 is an urging member that moves the dog member 5 in a second axial direction. The dog member 5 has a cylindrical main body 50 through which the coupling shaft 36 is inserted, and a collar 500 serving as a wall portion with an enlarged diameter and attached to an outer periphery of the main body 50. The input shaft 4 and the coupling shaft 36 share a rotation axis O. Hereinafter, a direction parallel to the rotation axis O is referred to as an axial direction.

The side gear 34R is an example of a “first rotating member” in the present invention, and the coupling shaft 36 is an example of a “second rotating member” in the present invention. The input shaft 4 is an example of a “fixed member” in the present invention, and the dog member 5 is an example of a “movable member” in the present invention. Furthermore, the electromagnetic actuator 6 and the coil spring 70 are examples of a “movement mechanism” in the present invention that moves the dog member 5 back and forth with respect to the coupling shaft 36 in the axial direction.

The differential gear mechanism 30, the differential case 31, and the connection-disconnection device 35 are housed in a case member 8 of the differential device 3. The case member 8 includes a first case element 81, a second case element 82, and a third case element 83. The second case element 82 integrally has a cylindrical outer wall portion 821 disposed between the first case element 81 and the third case element 83, and a partition wall portion 822 protruding inward from the outer wall portion 821. The partition wall portion 822 defines a housing space 8a in which the differential case 31 and the differential gear mechanism 30 are housed and a housing space 8b in which the dog member 5 and the electromagnetic actuator 6 of the connection-disconnection device 35 are housed. The differential case 31 is supported by a ball bearing 37 disposed between the partition wall portion 822 and the differential case 31.

The first case element 81 and the outer wall portion 821 of the second case element 82 are fixed to each other by bolts 84. The outer wall portion 821 of the second case element 82 and the third case element 83 are fixed to each other by a bolt 85. The third case element 83 integrally has a large-diameter cylindrical portion 831, a small-diameter cylindrical portion 832, and a disk portion 833 provided between the large-diameter cylindrical portion 831 and the small-diameter cylindrical portion 832.

Lubricating oil L is provided in the housing spaces 8a, 8b of the case member 8 for smooth operation of the differential gear mechanism 30 and the connection-disconnection device 35 to suppress wear. In the second case element 82, a communication passage 822a through which the lubricating oil L flows between the housing spaces 8a, 8b is formed so as to penetrate the partition wall portion 822. In the partition wall portion 822 of the second case element 82, a supply path 822b for supplying lubricating oil L to a radial needle roller bearing 71 and a thrust needle roller bearing 72 described later is formed.

The connection-disconnection device 35 can switch between a connected state in which the side gear 34R and the coupling shaft 36 are coupled to each other by the dog member 5 so as not to be rotatable relative to each other, and a released state in which the side gear 34R and the coupling shaft 36 are rotatable relative to each other.

The input shaft 4 integrally has a shaft portion 41, a cylindrical portion 42, a disk portion 43, and an annular meshing portion 44. The shaft portion 41 has a fitting portion 411 provided at one end of the shaft portion 41 fitting to the side gear 34R. The cylindrical portion 42 extends continuously from the other end of the shaft portion 41. The disk portion 43 projects radially outward from the cylindrical portion 42. The shaft portion 41 is inserted through a cylindrical extending portion 312 provided in the differential case 31, and the fitting portion 411 is spline-fitted to a fitting hole 341 of the side gear 34R. The meshing portion 44 is formed by arranging, in the circumferential direction, a plurality of dog teeth (meshing teeth) 441 protruding in the axial direction from an outer peripheral end portion of the disk portion 43.

The radial needle roller bearing 71 is disposed between an outer peripheral surface 42a of the cylindrical portion 42 of the input shaft 4 and the partition wall portion 822 of the second case element 82. The thrust needle roller bearing 72 is disposed between a shaft end surface 42b of the cylindrical portion 42 of the input shaft 4 and the partition wall portion 822 of the second case element 82. Axial movement of the input shaft 4 with respect to the side gear 34R in the first axial direction is restricted by the thrust needle roller bearing 72.

The coupling shaft 36 integrally has an axial shaft portion 361 aligned with the shaft portion 41 of the input shaft 4 in the axial direction, and a flange portion 362 to which the drive shaft 24R is coupled. A plurality of spline protrusions 363 extending in the axial direction are provided on an outer peripheral surface 361a of the shaft portion 361 of the coupling shaft 36. A snap ring 73 is fitted onto the outer peripheral surface 361a.

A boss portion 364 is provided on the shaft portion 361 at an end opposite to the flange portion 362, and a ball bearing 74 is disposed between the boss portion 364 and the cylindrical portion 42 of the input shaft 4. Axial movement of the input shaft 4 with respect to the side gear 34R in the second axial direction is restricted by the ball bearing 74. An oil passage 4a for supplying the lubricating oil L to the ball bearing 74 is formed in the input shaft 4. A ball bearing 75 and a seal member 76 are disposed between the outer peripheral surface 361a of the shaft portion 361 and an inner peripheral surface 832a of the small-diameter cylindrical portion 832 of the third case element 83.

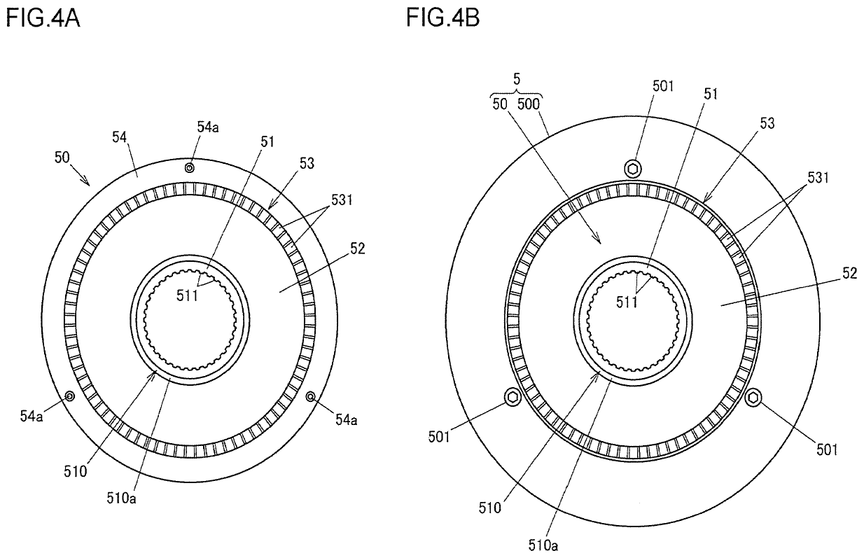

FIG. 4A is a view of the main body 50 of the dog member 5 as viewed from an input shaft 4 side, and FIG. 4B is a view of the main body 50 and the collar 500 of the dog member 5 as viewed from the input shaft 4 side. The main body 50 of the dog member 5 integrally has an annular fitting portion 51, a disk portion 52, an annular meshing portion 53, and a flange portion 54. A plurality of spline protrusions 511 meshing with the spline protrusions 363 of the coupling shaft 36 are provided on an inner peripheral surface of the fitting portion 51. The disk portion 52 projects radially outward from one end of the fitting portion 51. The flange portion 54 is for attaching the collar 500.

The dog member 5 is movable with respect to the coupling shaft 36 in the axial direction and non-rotatable relative to the coupling shaft 36, because the spline protrusions 511 mesh with the spline protrusions 363 of the coupling shaft 36. A recess 510 that houses the coil spring 70 and extends in the axial direction is provided in an inner peripheral end portion of the fitting portion 51 on a first axial side thereof. The coil spring 70 is disposed between a bottom surface 510a of the recess 510 and the snap ring 73 while being compressed in the axial direction. The meshing portion 53 is formed by arranging, in the circumferential direction, a plurality of dog teeth (meshing teeth) 531 protruding in the axial direction from an outer peripheral end portion of the disk portion 52.

The collar 500 is an annular plate-shaped member provided on an outer peripheral side with respect to the meshing portion 53, and is made of a metal such as iron or stainless steel. In the present embodiment, the inner and outer diameters of the collar 500 are uniform over the entire dog member 5 in a rotation direction, but the present invention is not limited to this. For example, the collar 500 may have a plurality of blade-shaped protrusions extending in the radial direction. As shown in FIGS. 3A and 3B, a plurality of through holes 500a are formed in an end portion on an inner peripheral side of the collar 500, and bolts 501 inserted through the through holes 500a are screwed into screw holes 54a formed in the flange portion 54 of the main body 50.

In the present embodiment, three through holes 500a are formed in the collar 500 at equal intervals, and the collar 500 is fixed to the flange portion 54 of the dog member 5 by three bolts 501. Alternatively, the collar 500 may be fixed to the main body 50 by welding. Further alternatively, the main body 50 and the collar 500 may be molded integrally.

The collar 500 is thinner than the disk portion 52 in axial thickness (plate thickness). That is, since the collar 500 is provided on the outer peripheral side with respect to the meshing portion 53, the collar 500 does not receive the drive force transmitted from the side gear 34R to the coupling shaft 36, and thus the collar 500 can be formed thinner than the disk portion 52. The dog member 5 is reduced in weight by forming the collar 500 thin.

The electromagnetic actuator 6 has an electromagnet 61, a yoke 62, and an armature 63. The electromagnet 61 has an electromagnetic coil 611 sealed by a sealing member 612 made of resin. The yoke 62 serves as a magnetic path for magnetic flux of the electromagnetic coil 611. The armature 63 is made of a soft magnetic material and moves in the axial direction by being attracted by the yoke 62 when the electromagnetic coil 611 is energized. The electromagnetic coil 611 is supplied with an excitation current from the control device 22 via an electric wire 613, thereby generating a magnetic force that attracts the armature 63 when energized.

The yoke 62 has an annular recess 620 that opens in the axial direction toward the armature 63, and the electromagnet 61 is housed in the recess 620. The yoke 62 is an annular soft magnetic body, and is fixed to the third case element 83 by a bolt 64. An end portion of the armature 63 on an inner peripheral side is aligned with the fitting portion 51 of the dog member 5 in the axial direction.

A thrust needle roller bearing 77 is disposed between the armature 63 and the fitting portion 51 of the dog member 5. With the magnetic force generated by the electromagnetic coil 611, the armature 63 presses the fitting portion 51 and moves together with the dog member 5 in the axial direction. When supply of the excitation current to the electromagnetic coil 611 is interrupted, the armature 63 abuts against an annular protrusion 834 provided on the disk portion 833 of the third case element 83 due to a restoring force of the coil spring 70 received via the dog member 5. In this manner, the armature 63 moves in the axial direction between an advanced position in which the armature 63 abuts against the yoke 62 and a retracted position in which the armature 63 abuts against the protrusion 834.

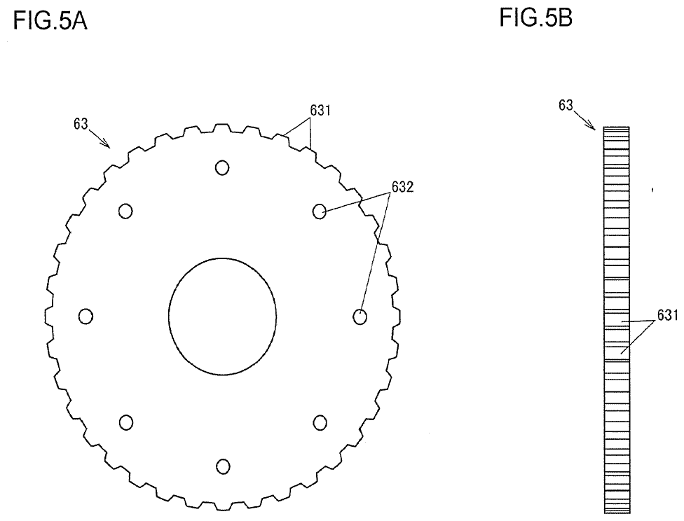

FIG. 5A is a plan view of the armature 63, and FIG. 5B is a side view of the armature 63. A plurality of spline protrusions 631 are provided on an outer peripheral surface of the armature 63 so as to extend in the axial direction. Since the spline protrusions 631 mesh with a plurality of spline protrusions 835 formed on an inner peripheral surface of the large-diameter cylindrical portion 831 of the third case element 83, the armature 63 is movable with respect to the third case element 83 in the axial direction and non-rotatable with respect to the third case element 83.

The armature 63 has a plurality of through holes 632 along a moving direction between the advanced position and the retracted position. In other words, the through holes 632 penetrate the armature 63 in the axial direction. In the present embodiment, eight through holes 632 are formed at equal intervals in the circumferential direction at positions facing the electromagnet 61 in the axial direction.

When the electromagnetic coil 611 is energized and the armature 63 moves from the retracted position to the advanced position, and when the current supply to the electromagnetic coil 611 is interrupted and the armature 63 moves from the advanced position to the retracted position, the armature 63 receives flow resistance of the lubricating oil L while allowing the lubricating oil L to flow through the through holes 632. Sizes of the through holes 632 are set such that the through holes 632 cause a moving speed of the armature 63 to moderately decrease by the flow resistance of the lubricating oil L, and mitigate a collision sound that may occur when the armature 63 abuts against the yoke 62 and the protrusion 834.

That is, if the through holes 632 are not formed in the armature 63, the moving speed of the armature 63 is significantly reduced by the flow resistance of the lubricating oil L, and responsiveness of the connection-disconnection device 35 is reduced. However, in the present embodiment, the armature 63 has the through holes 632 whose sizes are adjusted to inhibit the collision sound of the armature 63 from being heard as an abnormal noise by an occupant of the four-wheel drive vehicle 1. This makes it possible to suppress a reduction in the responsiveness of the connection-disconnection device 35 while suppressing the generation of abnormal noise.

When the dog member 5 moves toward the input shaft 4 by being pressed by the armature 63, the meshing portion 53 of the dog member 5 and the meshing portion 44 of the input shaft 4 mesh with each other. Thereby, the side gear 34R and the coupling shaft 36 are coupled to each other so as not to be relatively rotatable. When the dog member 5 is separated from the input shaft 4, the meshing portions 53 and 44 are unmeshed, and the side gear 34R and the coupling shaft 36 are relatively rotatable.

When the dog member 5 moves in the axial direction, the collar 500 receives the flow resistance of the lubricating oil L. Thereby, the collision sound that may occur between the dog teeth 441, 531 when the meshing portion 53 of the dog member 5 and the meshing portion 44 of the input shaft 4 mesh with each other is reduced to such an extent that the occupant of the four-wheel drive vehicle 1 does not hear the collision sound as an abnormal noise. Further, since the flow resistance of the lubricating oil L increases as the moving speed of the dog member 5 increases, a maximum moving speed of the dog member 5 can be limited by the collar 500.

According to the first embodiment of the present invention described above, since the dog member 5 has the collar 500, the generation of abnormal noise when the dog member 5 meshes with the input shaft 4 is suppressed. In addition, since the armature 63 has the through holes 632 whose sizes are adjusted, the generation of abnormal noise when the armature 63 abuts against the yoke 62 and the protrusion 834 is also suppressed, while suppressing the reduction in the responsiveness of the connection-disconnection device 35.

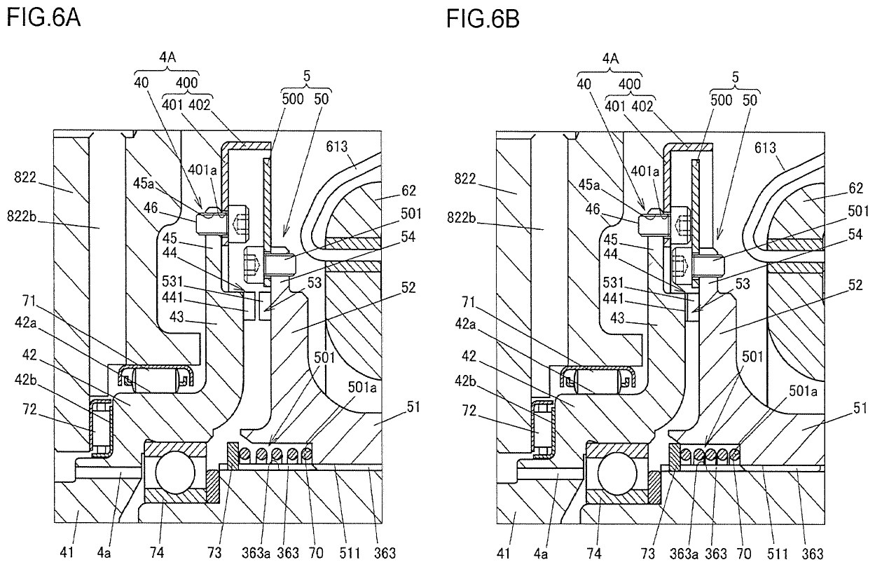

Next, a second embodiment of the present invention will be described with reference to FIGS. 6A and 6B. FIG. 6A is a sectional view showing a part of the connection-disconnection device 35 in a non-operating state, and FIG. 6B is a sectional view showing the part of the connection-disconnection device 35 in an operating state.

The second embodiment is different from the first embodiment in that an input shaft 4A has a plate 400 aligned with the collar 500 of the dog member 5 in the axial direction. Since the configuration of the second embodiment other than this is the same as that of the first embodiment, in FIGS. 6A and 6B, components common to those described in the first embodiment are given the same reference numerals as those in FIGS. 3A and 3B to omit repetitive description.

The input shaft 4A according to the second embodiment has a flange portion 45 and a plate 400 in addition to the shaft portion 41, the cylindrical portion 42, the disk portion 43, and the meshing portion 44. The shaft portion 41, the cylindrical portion 42, the disk portion 43, the meshing portion 44, and the flange portion 45 are integrally formed to constitute the main body 40 of the input shaft 4A. The flange portion 45 is for attaching the plate 400 to the main body 40, and extends further toward the outer peripheral side from the outer peripheral end portion of the disk portion 43. Alternatively, the main body 40 and the plate 400 may be integrally formed.

The plate 400 is made of, for example, a metal such as iron or stainless steel, and is provided on the outer peripheral side with respect to the meshing portion 44. The plate 400 integrally has an annular plate-shaped facing wall portion 401 facing the collar 500 in the axial direction, and a cylindrical tubular wall portion 402 protruding from an outer peripheral end portion of the facing wall portion 401 toward the collar 500. An inner diameter of the tubular wall portion 402 is larger than the outer diameter of the collar 500. When the meshing portion 44 of the input shaft 4A and the meshing portion 53 of the dog member 5 mesh with each other, the collar 500 is disposed inside the tubular wall portion 402.

A plurality of through holes 401a are formed in an end portion on an inner peripheral side of the facing wall portion 401, and bolts 46 inserted through the through holes 401a are screwed into screw holes 45a formed in the flange portion 45.

According to the second embodiment of the present invention described above, since the input shaft 4A has the plate 400, when the dog member 5 moves toward the input shaft 4A, the flow resistance of the lubricating oil L received by the collar 500 is further increased as compared with the first embodiment. Thereby, the abnormal noise that may occur when the meshing portion 53 of the dog member 5 and the meshing portion 44 of the input shaft 4A mesh with each other is further reduced.

The embodiments may be modified in various ways within the scope of the invention. For example, in the above embodiments, the connection-disconnection device 35 is applied to the differential device 3 for the four-wheel drive vehicle 1. However, applications for the connection-disconnection device 35 is not limited to this, and the connection-disconnection device 35 may be applied to other vehicles as well as various industrial machines.

What is claimed is:

1. A connection-disconnection device configured to switch between a connected state in which a first rotating member and a second rotating member are coupled to each other so as not to be rotatable relative to each other, and a released state in which the first rotating member and the second rotating member are rotatable relative to each other, the first rotating member and the second rotating member each supported by a case member so as to be rotatable relative to the case member, the connection-disconnection device comprising:
a fixed member coupled to the first rotating member so as not to be rotatable relative to the first rotating member, axial movement of the fixed member being restricted with respect to the first rotating member;
a movable member coupled to the second rotating member so as not to be rotatable relative to the second rotating member and so as to be movable with respect to the second rotating member in an axial direction; and
a moving mechanism configured to move the movable member back and forth with respect to the second rotating member in the axial direction, wherein:
each of the fixed member and the movable member has an annular meshing portion formed by arranging a plurality of meshing teeth in a circumferential direction;
when the movable member is moved toward the fixed member by the moving mechanism, the meshing portion of the movable member and the meshing portion of the fixed member mesh with each other; and
the movable member has a wall portion with an enlarged diameter provided on an outer peripheral side with respect to the meshing portion, the wall portion configured to receive a flow resistance of lubricating oil accommodated in the case member when the movable member moves in the axial direction.

2. The connection-disconnection device according to claim 1, wherein:
the moving mechanism has an electromagnet including an electromagnetic coil that generates a magnetic force under energization, and an armature that moves together with the movable member with the magnetic force;
through holes are formed in the armature along a moving direction of the armature; and
when the electromagnetic coil is energized, the armature receives the flow resistance of the lubricating oil while allowing the lubricating oil to flow through the through holes.

3. The connection-disconnection device according to claims 1, wherein the fixed member has a facing wall portion provided on the outer peripheral side with respect to the meshing portion, the facing wall portion facing the wall portion with the enlarged diameter.

4. The connection-disconnection device according to claim 3, wherein the fixed member further has a tubular wall portion protruding from an outer peripheral end portion of the facing wall portion toward the wall portion with the enlarged diameter.

5. A differential device for a vehicle, the differential device distributing a drive force of a drive source to a pair of drive shafts while allowing a differential operation, the differential device comprising:
the connection-disconnection device according to claim 1;
a differential case configured to rotate with the drive force of the drive source of the vehicle;
a plurality of pinion gears configured to rotate together with the differential case; and
a pair of side gears configured to mesh with the pinion gears, wherein
the connection-disconnection device couples and uncouples one side gear of the pair of side gears and one drive shaft of the pair of drive shafts.
